(19) United States
(12) Patent Application Publication
(10) Pub. No.: US 2024/0276324 A1
(43) Pub. Date: Aug. 15, 2024

(54) APPARATUS AND METHOD FOR CELL MISMATCH HANDLING IN IDLE/INACTIVE STATE OPERATION OF NETWORK CONTROLLED REPEATER IN NEXT GENERATION COMMUNICATION SYSTEM

(71) Applicant: Samsung Electronics Co., Ltd., Gyeonggi-do (KR)

(72) Inventors: June HWANG, Gyeonggi-do (KR); Anil AGIWAL, Gyeonggi-do (KR)

(21) Appl. No.: 18/434,107

(22) Filed: Feb. 6, 2024

(30) Foreign Application Priority Data
Feb. 9, 2023 (KR) 10-2023-0017202

(51) Int. Cl. H04W 36/00; H04W 76/30

(52) U.S. Cl. CPC H04W 36/00837; H04W 76/30

(57) ABSTRACT

The disclosure relates to fifth generation (5G) or sixth generation (6G) communication systems capable of supporting higher data rates and discloses a method and apparatus that enable the mobile termination (MT) of a network controlled repeater (NCR) to perform repeater control in an idle/inactive situation. The method includes performing, by a forward (Fwd) of the NCR node (NCR-Fwd), signal forwarding between a terminal and a base station based on first control information received from the base station, receiving, by a mobile termination (MT) of the NCR node (NCR-MT) from the base station, a radio resource control (RRC) release message, performing, by the NCR-MT, cell reselection in an RRC inactive state based on the RRC release message including information on a suspend configuration, and indicating, by the NCR-MT, to the NCR-Fwd, to cease the signal forwarding, in case that the NCR-MT reselects a cell other than a last serving cell of the base station.

### CROSS-REFERENCE TO RELATED APPLICATION(S)

This application is based on and claims priority under 35 U.S.C. § 119 to Korean Patent Application No. 10-2023-0017202, filed on Feb. 9, 2023, in the Korean Intellectual Property Office, the disclosure of which is incorporated herein by reference in its entirety.

### BACKGROUND

### 1. Field

The disclosure relates generally to a network controlled repeater (NCR) in a mobile communication system, and more particularly, to a technology for the mobile termination (MT) of an NCR to perform repeater control in an idle/inactive situation in the mobile communication system.

### 2. Description of Related Art

Fifth generation (5G) mobile communication technology defines a wide frequency band to enable fast transmission speed and new services, and can be implemented not only in a sub-6 gigahertz (GHz) frequency band such as 3.5 GHz but also in an ultra-high frequency band (above 6 GHZ) referred to as millimeter wave (mm Wave) such as 28 GHz or 39 GHz. In addition, sixth generation (6G) mobile communication technology referred to as a beyond 5G system is being considered for implementation in a terahertz (THz) band (e.g., band of 95 GHz to 3 THz) to achieve transmission speed that is 50 times faster and ultra-low latency that is reduced to 1/10 compared with 5G mobile communication technology.

At the inception of 5G mobile communication technology, to meet service support and performance requirements for enhanced mobile broadband (eMBB), ultra-reliable and low-latency communication (URLLC), and massive machine-type communications (mMTC), standardization has been performed regarding beamforming for mitigating the pathloss of radio waves and increasing the propagation distance thereof in the mm Wave band, massive multiple input multiple output (MIMO), support of various numerology for efficient use of ultra-high frequency resources (e.g., operating multiple subcarrier spacings), dynamic operations on slot formats, initial access schemes to support multi-beam transmission and broadband, definition and operation of bandwidth part (BWP), new channel coding schemes such as low density parity check (LDPC) codes for large-capacity data transmission and polar codes for reliable transmission of control information, layer 2 (L2) pre-processing, and network slicing for providing a dedicated network specialized for a specific service.

Discussions are underway to improve 5G mobile communication technology and enhance performance thereof in consideration of the services that the 5G mobile communication technology has initially intended to support, and physical layer standardization is in progress for technologies such as vehicle-to-everything (V2X) that aims to help a self-driving vehicle to make driving decisions based on its own location and status information transmitted by vehicles and to increase user convenience, new radio unlicensed (NR-U) for system operation that meets various regulatory requirements in unlicensed bands, low power consumption scheme for NR terminals (UE power saving), non-terrestrial network (NTN) as direct terminal-satellite communication to secure coverage in an area where communication with a terrestrial network is not possible, and positioning.

In addition, standardization in radio interface architecture/protocol is in progress for technologies such as industrial Internet of things (IIoT) for new service support through linkage and convergence with other industries, integrated access and backhaul (IAB) that provides nodes for network service area extension by integrating and supporting wireless backhaul links and access links, mobility enhancement including conditional handover and dual active protocol stack (DAPS) handover, 2-step random access (2-step RACH for NR) that simplifies the random access procedure; and standardization in system architecture/service is also in progress for the 5G baseline architecture (e.g., service based architecture, service based interface) for integrating network functions virtualization (NFV) and software defined networking (SDN) technologies, and mobile edge computing (MEC) where the terminal receives a service based on its location.

When such a 5G mobile communication system is commercialized, connected devices that are ever-increasing will be connected to the communication networks. Thus, it is expected that enhancement in function and performance of the 5G mobile communication system and the integrated operation of the connected devices will be required. To this end, new research will be conducted regarding 5G performance improvement and complexity reduction, artificial intelligence (AI) service support, metaverse service support, and drone communication by utilizing extended reality (XR) for efficiently supporting augmented reality (AR), virtual reality (VR), and mixed reality (MR), AI, and machine learning (ML).

Such advancement of 5G mobile communication systems will be the basis for the development of technologies such as new waveforms for ensuring coverage in the THz band of 6G mobile communication technology, full dimensional MIMO (FD-MIMO), multi-antenna transmission such as array antenna or large scale antenna, metamaterial-based lenses and antennas for improved coverage of terahertz band signals, high-dimensional spatial multiplexing using orbital angular momentum (OAM), reconfigurable intelligent surface (RIS) technique, full duplex technique to improve frequency efficiency and system network of 6G mobile communication technology, satellites, AI-based communication that utilizes AI from the design stage and internalizes end-to-end AI support functions to realize system optimization, and next-generation distributed computing that realizes services whose complexity exceeds the limit of terminal computing capabilities by utilizing ultra-high-performance communication and computing resources.

As the advancement of mobile communication systems enables the provision of various services, a method for effectively providing these services is required. For example, to provide various services, an NCR that performs both forwarding and MT functions can be used. A forward (FWD) function performs operations of receiving, amplifying, and forwarding signals, and the MT function performs operations of receiving a beam-related configuration and transferring it to the FWD function. Additionally, the MT function can, as a type of terminal function, perform an operation such as cell reselection.

When cell reselection is performed by the MT of such an NCR, the cell targeted for signal amplification and the reselected cell may differ, thereby causing an inefficiency in use of resources in the communication system. Therefore, there is a need in the art for a method and apparatus that cures the problem of a mismatch between a targeted cell and a reselected cell in the mobile communication system.

### SUMMARY

This disclosure has been made to address at least the above-mentioned problems and/or disadvantages and to provide at least the advantages described below.

Accordingly, an aspect of the disclosure is to provide a method and apparatus by which the two cells are matched even if there is a disparity between the cell to which the network controlled repeater applies amplification and the cell selected due to cell reselection.

In accordance with an aspect of the disclosure, a method performed by a network-controlled repeater (NCR) node in a communication system includes performing, by a forward (Fwd) of the NCR node (NCR-Fwd), signal forwarding between a terminal and a base station based on first control information received from the base station, receiving, by a mobile termination (MT) of the NCR node (NCR-MT) from the base station, a radio resource control (RRC) release message, performing, by the NCR-MT, cell reselection in an RRC inactive state based on the RRC release message including information on a suspend configuration, and indicating, by the NCR-MT, to the NCR-Fwd, to cease the signal forwarding, in case that the NCR-MT reselects a cell other than a last serving cell of the base station.

In accordance with an example of the disclosure, an NCR node in a communication system includes a transceiver, and a controller configured to control a Fwd of the NCR node (NCR-Fwd) to perform signal forwarding between a terminal and a base station based on first control information received from the base station, control an NCR-MT to receive, from the base station, an RRC release message, control the NCR-MT to perform cell reselection in an RRC inactive state based on the RRC release message including information on a suspend configuration, and control the NCR-MT to indicate, to the NCR-Fwd, ceasing of the signal forwarding, in case that the NCR-MT reselects a cell other than a last serving cell of the base station.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates the general architecture of a long term evolution (LTE) system to which the disclosure is applied;

FIG. 2 illustrates the general structure of radio protocols in an LTE system to which the disclosure is applied;

FIG. 3 illustrates the architecture of a next-generation mobile communication system according to an embodiment;

FIG. 4 illustrates the structure of radio protocols in a next-generation mobile communication system according to an embodiment;

FIG. 5 illustrates the internal structure of a UE according to an embodiment;

FIG. 6 illustrates the structure of an NR base station (BS) according to an embodiment;

FIG. 7 illustrates when the MT is disallowed for cell reselection according to an embodiment;

FIG. 8 illustrates when the MT is allowed for cell reselection but the FWD is turned off according to an embodiment;

FIG. 9 illustrates when the MT is allowed for cell reselection but redirection is made to the original cell according to an embodiment; and

FIG. 10 illustrates when the FWD performs amplification/forwarding for plural cells according to an embodiment.

### DETAILED DESCRIPTION

Embodiments of the present disclosure will be described in detail with reference to the accompanying drawings. Descriptions of well-known functions and structures incorporated herein may be omitted for the sake of clarity and conciseness. The terms described below are defined in consideration of their functions in the disclosure and may vary depending on the intention of the user, the operator, or the custom. Hence, their meanings should be determined based on the overall contents of this specification.

Those terms used in the following description for identifying an access node and for indicating a network entity, a message, an interface between network entities, and various identification information is taken as illustration for ease of description. Accordingly, the disclosure is not limited by the terms to be described later, and other terms referring to objects having an equivalent technical meaning may be used.

Herein, the elements included in the disclosure are expressed in a singular or plural form according to the embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

In the following description, the BS, as a main agent that allocates resources to a terminal, may be at least one of Node B, eNode B, gNode B, radio access unit, BS controller, or node on a network. The terminal may include a user equipment (UE), a mobile station (MS), a cellular phone, a smartphone, a computer, or a multimedia system capable of performing a communication function. In the disclosure, a downlink (DL) refers to a wireless transmission path through which a BS transmits a signal to a terminal, and an uplink (UL) refers to a wireless transmission path through which a terminal transmits a signal to a BS. The disclosure may be described by using LTE or LTE-A systems as an example, but may be applied to other communication systems having similar technical backgrounds or channel configurations, such as the 5th generation mobile communication technology (5G, new radio, NR) developed after LTE-A. 5G includes existing LTE, LTE-A, and other similar services. The disclosure is applicable to other communication systems without significant modifications departing from the scope of the disclosure.

For convenience of description below, the disclosure uses terms and names defined in the 5GS and NR standards, which are standards defined by the third generation partnership project (3GPP) organization among currently existing communication standards. However, the disclosure is not limited by the above terms and names and can be equally applied to wireless communication networks conforming to other standards. For example, the disclosure can be applied to 3GPP 5GS/NR (5th generation mobile communication standards).

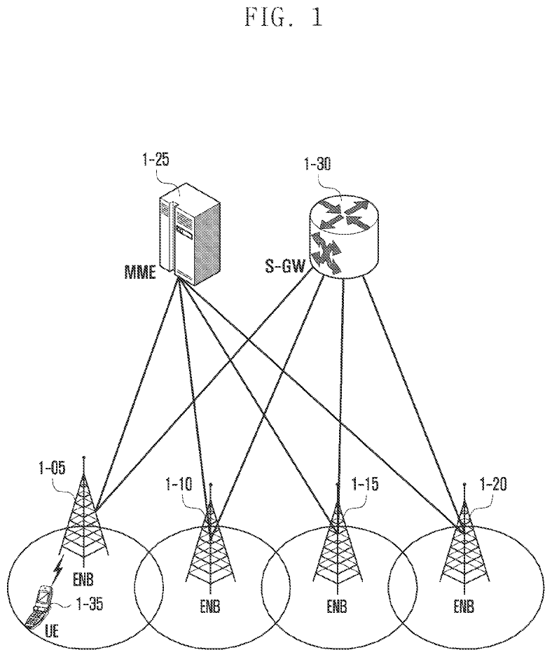

FIG. 1 illustrates the general architecture of an LTE system to which the disclosure is applied.

In FIG. 1, (evolved node B (ENB) or node B 1-05, 1-10, 1-15 or 1-20, a mobility management entity (MME) 1-25, and a serving-gateway (S-GW) 1-30. A UE (or terminal) 1-35 may connect to an external network through the ENB 1-05, 1-10, 1-15 or 1-20 and the S-GW 1-30.

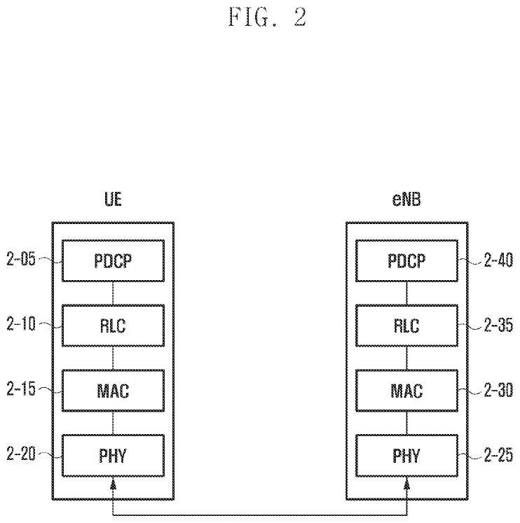

In FIG. 1, the ENBs 1-05 to 1-20 correspond to existing Node Bs of the universal mobile telecommunication system (UMTS). The ENB is connected to the UE 1-35 through a radio channel, but performs more complex functions in comparison to the existing Node B. In the LTE system, all user traffic including real-time services such as voice over Internet protocol (VoIP) may be served through shared channels. Hence, an apparatus is needed to perform scheduling based on collected status information regarding buffers, available transmit powers and channels of the UEs, and the ENBs 1-05 to 1-20 can be responsible for this. One ENB may control multiple cells in a typical situation. To achieve a data rate of, for example, 100 megabits per second (Mbps) in a bandwidth of, for example, 20 MHz, the LTE system may utilize orthogonal frequency division multiplexing (OFDM) as radio access technology. The LTE system may apply adaptive modulation and coding (AMC) to determine the modulation scheme and channel coding rate according to channel states of the UE. The S-GW 1-30 provides data bearers and may create and remove data bearers under the control of the MME 1-25. The MME controls various control functions including a mobility management function for the UE and may be connected to a plurality of ENBs. FIG. 2 illustrates the structure of radio protocols in an existing LTE system to which the disclosure is applied.

Referring to FIG. 2, in a UE or an ENB, the radio protocols of the LTE system may be composed of packet data convergence protocol (PDCP) 2-05 and 2-40, radio link control (RLC) 2-10 and 2-35, and medium access control (MAC) 2-15 and 2-30. The PDCP may perform compression and decompression of IP headers. The main functions of the PDCP may be summarized as robust header compression (ROHC), user data transfer, in-sequence delivery of upper layer packet data units (PDUs) at a packet data convergence protocol (PDCP) re-establishment procedure for RLC acknowledged mode (AM), reordering for split bearers in DC (only support for RLC AM): PDCP PDU routing for transmission and PDCP PDU reordering for reception), duplicate detection of lower layer service data units (SDUs) at a PDCP re-establishment procedure for RLC AM, retransmission of PDCP SDUs at handover and, for split bearers in DC, of PDCP PDUs at PDCP data-recovery procedure, for RLC AM, ciphering and deciphering, and a timer-based SDU discard in the UL.

The radio link control (RLC) 2-10 and 2-35 may reconfigure PDCP PDUs to a suitable size and perform ARQ operation. The main functions of the RLC may be summarized as data transfer of upper layer PDUs, error correction through automatic repeat request (ARQ) for AM data transfer, concatenation, segmentation and reassembly of RLC SDUs for unacknowledged mode (UM) and AM data transfer, re-segmentation of RLC data PDUs for AM data transfer, reordering of RLC data PDUs for UM and AM data transfer, duplicate detection for UM and AM data transfer, protocol error detection for AM data transfer, RLC SDU discard for UM and AM data transfer, and RLC re-establishment.

The MAC 2-15 and 2-30 may be connected to multiple RLC entities configured in a UE and may multiplex RLC PDUs into MAC PDUs and demultiplex MAC PDUs into RLC PDUs. The main functions of the MAC may be mapping between logical channels and transport channels, multiplexing/demultiplexing of MAC SDUs belonging to one or different logical channels into/from transport blocks (TBs) delivered to/from the physical layer on transport channels, scheduling information reporting, hybrid automatic repeat request (HARQ) error correction, priority handling between logical channels of one UE, priority handling between UEs by means of dynamic scheduling, multimedia broadcast multicast service (MBMS) identification, transport format selection, and padding.

The physical (PHY) layer 2-20 and 2-25 may convert higher layer data into OFDM symbols by means of channel coding and modulation and transmits the OFDM symbols through a radio channel, or it may demodulate OFDM symbols received through a radio channel, perform channel decoding, and forward the result to a higher layer.

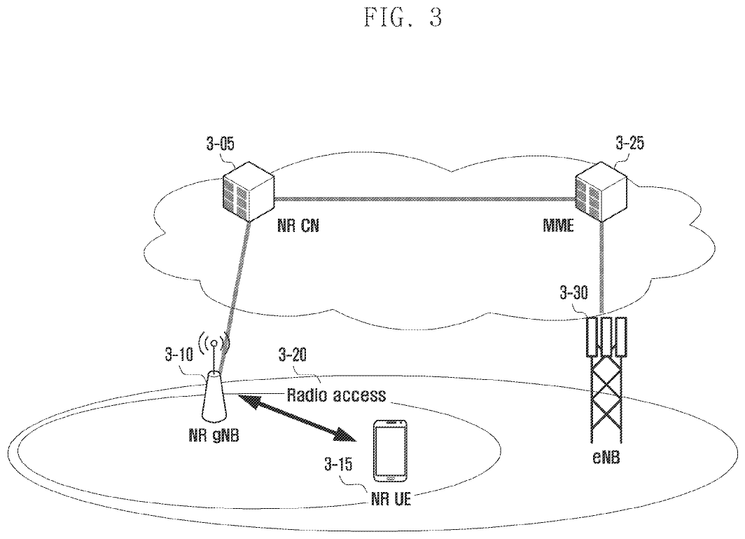

FIG. 3 illustrates the architecture of a next-generation mobile communication system to which the disclosure is applied.

in FIG. 3, the radio access network of an NR or 5G system may be composed of a new radio node B (NR gNB or NR BS) 3-10 and a new radio core network (NR CN) 3-05. An NR UE 3-15 may connect to an external network through the NR gNB 3-10 and the NR CN 3-05.

In FIG. 3, the NR gNB 3-10 may correspond to an eNB of the existing LTE system. The NR gNB may be connected to the NR UE 3-15 through a radio channel, and it can provide a better service than that of the existing node B. All user traffic may be serviced through shared channels in the next-generation mobile communication system. Hence, there is a need for an entity that performs scheduling by collecting status information, such as buffer states, available transmission power states, and channel states of individual UEs, and the NR NB 3-10 may take charge of this scheduling. One NR gNB may control a plurality of cells. To implement ultra-high-speed data transmission compared with normal LTE, a bandwidth beyond the general maximum bandwidth may be utilized in the next-generation mobile communication system. A beamforming technology may be additionally combined with OFDM serving as a radio access technology. An adaptive modulation and coding (AMC) scheme determining a modulation scheme and channel coding rate to match the channel state of the UE may be applied. The NR CN 3-05 may perform functions such as mobility support, bearer configuration, and quality of service (QOS) configuration. The NR CN controls not only mobility management but also various control functions for the UE, and may be connected to a plurality of BSs. In addition, the next-generation mobile communication system may interwork with the LTE system, and the NR CN may be connected to the MME 3-25 through a network interface. The MME may be connected to an eNB 3-30 being an LTE BS.

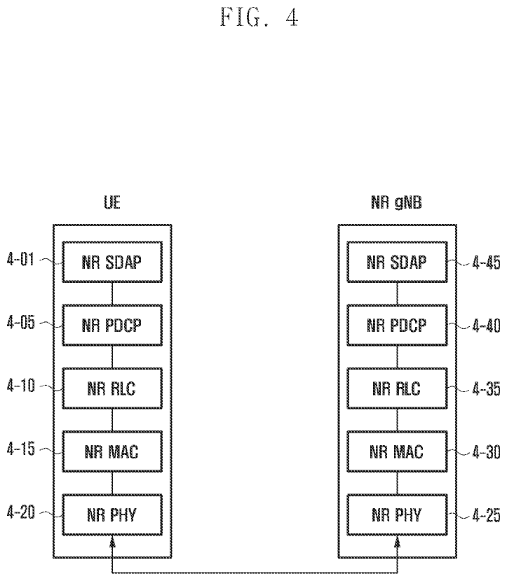

FIG. 4 illustrates the structure of radio protocols in a next-generation mobile communication system, to which the disclosure is applied.

Referring to FIG. 4, in a UE or an NR gNB, the radio protocols of the next-generation mobile communication system are composed of NR service data adaptation protocol (SDAP) 4-01 and 4-45, NR PDCP 4-05 and 4-40, NR RLC 4-10 and 4-35, NR MAC 4-15 and 4-30, and NR PHY 4-20 and 4-25.

The main functions of the NR SDAP 4-01 and 4-45 may include transfer of user plane data, mapping between a quality of service (QOS) flow and a DRB for both the DL and the UL, marking QoS flow ID in both DL and UL packets, and reflective QoS flow to DRB mapping for the UL SDAP PDUs.

With respect to the SDAP entity, the UE may be configured with, through a radio resource control (RRC) message, whether to use a header of the SDAP entity or whether to use a function of the SDAP entity for each PDCP entity, bearer, or logical channel. If an SDAP header is configured, the UE may use a non-access stratum (NAS) reflective QoS 1-bit indication and AS (access stratum) reflective QoS 1-bit indication of the SDAP header to instruct the UE to update or reconfigure the mapping information between QoS flows and data bearers for the UL and the DL. The SDAP header may include QoS flow ID information indicating the QoS. The QoS information may be used as data processing priority and scheduling information for supporting smooth services.

The main function of the NR PDCP 4-05 and 4-40 may include ROHC, transfer of user data, in-sequence delivery of upper layer PDUs, out-of-sequence delivery of upper layer PDUs, PDCP PDU reordering for reception, duplicate detection of lower layer SDUs, retransmission of PDCP SDUs, ciphering and deciphering, and timer-based SDU discard in the UL.

In the above description, the reordering function of the NR PDCP entity may mean reordering of PDCP PDUs received from a lower layer in order based on the PDCP sequence number (SN). The reordering function of the NR PDCP entity may include delivering data to an upper layer in reordered sequence, directly delivering data without considering the order, recording lost PDCP PDUs through reordering, reporting the status of lost PDCP PDUs to the transmitting side, or requesting retransmission of the lost PDCP PDUs.

The main function of the NR RLC 4-10 and 4-35 may include transfer of upper layer PDUs, in-sequence delivery of upper layer PDUs, out-of-sequence delivery of upper layer PDUs, error correction through ARQ, concatenation, segmentation and reassembly of RLC SDUs, re-segmentation of RLC data PDUs, reordering of RLC data PDUs, duplicate detection, protocol error detection, RLC SDU discard, and RLC re-establishment.

In the above description, in-sequence delivery of the NR RLC entity may mean in-sequence delivery of RLC SDUs received from a lower layer to an upper layer. In-sequence delivery of the NR RLC entity may include reassembly and delivery of RLC SDUs when several RLC SDUs belonging to one original RLC SDU are received after segmentation.

In-sequence delivery of the NR RLC entity may include reordering of received RLC PDUs based on the RLC sequence number (SN) or the PDCP SN, recording lost RLC PDUs through reordering, reporting the status of the lost RLC PDUs to the transmitting side, and requesting retransmission of the lost RLC PDUs.

If there is a lost RLC SDU, in-sequence delivery of the NR RLC entity may include in-sequence delivery of only RLC SDUs before the lost RLC SDU to an upper layer.

Although there is a lost RLC SDU, if a specified timer has expired, in-sequence delivery of the NR RLC entity may include in-sequence delivery of all the RLC SDUs received before the starting of the timer to an upper layer, and may include in-sequence delivery of all the RLC SDUs received up to the current time to an upper layer.

The NR RLC entity may process RLC PDUs in the order of reception regardless of the order of the sequence number and transfer the RLC PDUs to the NR PDCP entity in an out-of-sequence delivery manner.

When receiving a segment, the NR RLC entity may reconstruct one entire RLC PDU from segments stored in the buffer or received later and transfer the RLC PDU to the NR PDCP entity.

The NR RLC layer may not include a concatenation function, which may be performed by the NR MAC layer or may be replaced with a multiplexing function of the NR MAC layer.

In the above description, out-of-sequence delivery of the NR RLC entity may mean a function of transferring RLC SDUs received from a lower layer directly to a higher layer regardless of their order. If several RLC SDUs belonging to one original RLC SDU are received after segmentation, out-of-sequence delivery of the NR RLC entity may include reassembly and delivery of the RLC SDUs. Out-of-sequence delivery of the NR RLC entity may include storing the RLC SNs or PDCP SNs of received RLC PDUs and ordering them to record lost RLC PDUs.

The NR MAC 4-15 and 4-30 may be connected to several NR RLC entities configured in one UE, and the main function of the NR MAC may include mapping between logical channels and transport channels, multiplexing/demultiplexing of MAC SDUs, scheduling information reporting, error correction through HARQ, priority handling between logical channels of one UE, priority handling between UEs by means of dynamic scheduling, MBMS service identification, transport format selection, and padding.

The NR PHY 4-20 and 4-25 may compose OFDM symbols from higher layer data through channel coding and modulation and transmit them through a radio channel, or may demodulate and channel-decode OFDM symbols received through a radio channel and forward the result to a higher layer.

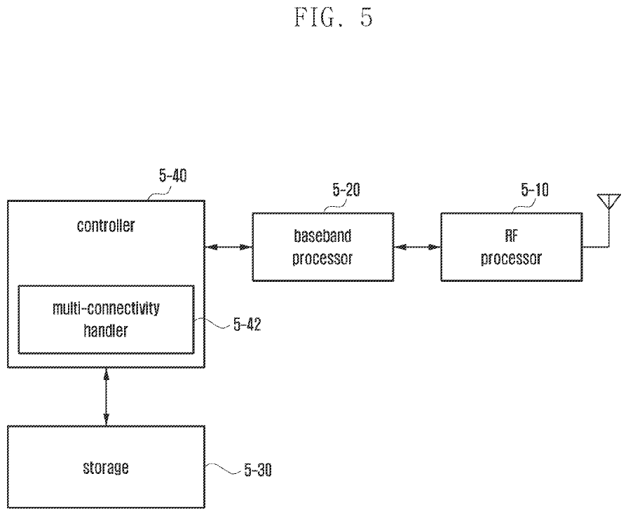

FIG. 5 illustrates the structure of a UE according to an embodiment.

Referring to FIG. 5, the UE includes a radio frequency (RF) processor 5-10, a baseband processor 5-20, a storage 5-30, and a controller 5-40.

The RF processor 5-10 performs a function for transmitting and receiving a signal through a radio channel, such as signal band conversion and amplification. The RF processor 5-10 performs up-conversion of a baseband signal provided from the baseband processor 5-20 into an RF-band signal and transmits it through an antenna and performs down-conversion of an RF-band signal received through an antenna into a baseband signal. For example, the RF processor 5-10 may include a transmission filter, a reception filter, an amplifier, a mixer, an oscillator, a digital-to-analog converter (DAC), and an analog-to-digital converter (ADC). Although only one antenna is illustrated in the drawing, the UE may be provided with a plurality of antennas. The RF processor 5-10 may include a plurality of RF chains and may perform beamforming by adjusting phases and magnitudes of individual signals transmitted and received through the plural antennas or antenna elements. The RF processor may perform MIMO, and may receive several layers during an MIMO operation.

The baseband processor 5-20 performs conversion between a baseband signal and a bit stream in accordance with the physical layer specification of the system. For example, during data transmission, the baseband processor 5-20 generates complex symbols by encoding and modulating a transmission bit stream. During data reception, the baseband processor 5-20 restores a reception bit stream by demodulating and decoding a baseband signal provided from the RF processor 5-10. For example, when utilizing OFDM, for data transmission, the baseband processor 5-20 generates complex symbols by encoding and modulating a transmission bit stream, maps the complex symbols to subcarriers, and composes OFDM symbols through inverse fast Fourier transform (IFFT) operation and cyclic prefix (CP) insertion. For data reception, the baseband processor 5-20 divides a baseband signal provided from the RF processor 5-10 in units of OFDM symbols, restores the signals mapped to subcarriers through fast Fourier transform (FFT) operation, and restores the reception bit stream through demodulation and decoding.

The baseband processor 5-20 and the RF processor 5-10 transmit and receive signals as described above. Hence, the baseband processor 5-20 and the RF processor 5-10 may be called a transmitter, a receiver, a transceiver, or a communication unit. To support different radio access technologies, at least one of the baseband processor 5-20 or the RF processor 5-10 may include a plurality of communication modules. In addition, to process signals of different frequency bands, at least one of the baseband processor 5-20 or the RF processor 5-10 may include different communication modules. For example, the different radio access technologies may include a wireless LAN (e.g., IEEE 802.11), a cellular network (e.g., LTE), and the like. In addition, the different frequency bands may include a super high frequency (SHF) band (e.g., 2.NRHz, NRhz) and an mm Wave band (e.g., 60 GHz).

The storage 5-30 stores data such as basic programs, application programs, and configuration information for the operation of the UE. In particular, the storage 5-30 may store information about a second access node that performs wireless communication using a second radio access technology. The storage 5-30 provides stored data in response to a request from the controller 5-40.

The controller 5-40 controls the overall operation of the UE. For example, the controller 5-40 transmits and receives signals through the baseband processor 5-20 and the RF processor 5-10 and writes or reads data to or from the storage 5-40. To this end, the controller 5-40 may include at least one processor. For example, the controller 5-40 may include a communication processor for controlling communication and an application processor (AP) for controlling higher layers such as application programs.

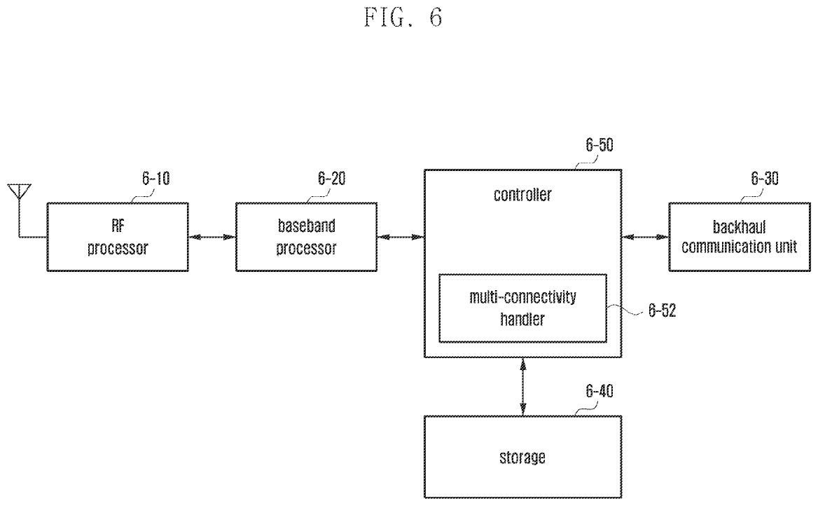

FIG. 6 illustrates the structure of an NR BS according to an embodiment.

Referring to FIG. 6, the NR BS includes an RF processor 6-10, a baseband processor 6-20, a backhaul communication unit 6-30, a storage 6-40, and a controller 6-50.

The RF processor 6-10 performs a function for transmitting and receiving a signal through a radio channel, such as signal band conversion and amplification. The RF processor 6-10 performs up-conversion of a baseband signal provided from the baseband processor 6-20 into an RF-band signal and transmits the converted signal through an antenna and performs down-conversion of an RF-band signal received through an antenna into a baseband signal. For example, the RF processor 6-10 may include a transmission filter, a reception filter, an amplifier, a mixer, an oscillator, a DAC, and an ADC. Although only one antenna is illustrated in the drawing, the first access node may be provided with a plurality of antennas. Additionally, the RF processor 6-10 may include a plurality of RF chains. The RF processor 6-10 may perform beamforming. For beamforming, the RF processor 6-10 may adjust phases and amplitudes of individual signals transmitted and received through plural antennas or antenna elements. The RF processor may perform DL MIMO operation by transmitting one or more layers.

The baseband processor 6-20 performs conversion between a baseband signal and a bit stream in accordance with the physical layer specification of a first radio access technology. For example, for data transmission, the baseband processor 6-20 generates complex symbols by encoding and modulating a transmission bit stream. For data reception, the baseband processor 6-20 restores a reception bit stream by demodulating and decoding a baseband signal provided from the RF processor 6-10. For example, when utilizing OFDM, for data transmission, the baseband processor 6-20 generates complex symbols by encoding and modulating a transmission bit stream, maps the complex symbols to subcarriers, and composes OFDM symbols through IFFT operation and CP insertion. For data reception, the baseband processor 6-20 divides a baseband signal provided from the RF processor 6-10 in units of OFDM symbols, restores the signals mapped to subcarriers through FFT operation, and restores the reception bit stream through demodulation and decoding. The baseband processor 6-20 and the RF processor 6-10 transmit and receive signals as described above. Hence, the baseband processor 6-20 and the RF processor 6-10 may be called a transmitter, a receiver, a transceiver, a communication unit, or a wireless communication unit.

The backhaul communication unit 6-30 provides an interface for communication with other nodes in the network. The backhaul communication unit 6-30 converts a bit stream, which is to be transmitted from the primary BS to another node, such as a secondary BS or the core network, into a physical signal, and converts a physical signal received from another node into a bit stream.

The storage 6-40 stores data such as basic programs, application programs, and configuration information for the operation of the primary BS. In particular, the storage 6-40 may store information on a bearer allocated to a connected UE and measurement results reported from the connected UE. The storage 6-40 may store information used as a criterion for determining whether to provide or suspend multi-connectivity to the UE. In addition, the storage 6-40 provides stored data in response to a request from the controller 6-50.

The controller 6-50 controls the overall operation of the NR BS. For example, the controller 6-50 transmits and receives signals through the baseband processor 6-20 and the RF processor 6-10 or through the backhaul communication unit 6-30. The controller 6-50 writes or reads data to or from the storage 6-40. To this end, the controller 6-50 may include at least one processor.

The NCR disclosed herein is divided into an MT part and an FWD part. The FWD part receives a signal from a cell and amplifies and forwards the signal, or receives signals from UEs, amplifies the signals, and forwards the signals toward an NR BS. In addition, the MT part can receive a beam-related configuration of the FWD part from the NR BS and transfer the beam-related configuration to the FWD part.

The state of the FWD can be set to ON and OFF. ON may indicate when the FWD amplifies a signal of the cell and forwards the signal to a UE or amplifies a signal of the UE and forwards it to a cell of the NR BS. OFF may indicate when signal reception and amplification is not performed (i.e., is suspended).

For reference, the contents of the agreement after 3GPP RAN2 #120 related to the NCR of this disclosure are shown below in Table 1.

TABLE 1

| | • | NCR MT can be connected, inactive, and IDLE |
|---|---|---|
| | | • Release to IDLE is FFS. |
| | • | NCR FWD would be ON or OFF |
| | • | For inactive/idle mode of MT, FWD can be ON or OFF by |
| | following the latest configuration given from serving cell | |
| | • | For inactive/idle state MT, cell reselection is mandatory supported. |
| • | Further related agreements | |
| | • | gNB cell that NCR-Fwd is forwarding is the same cell the NCT-MT |
| | is connected to. | |
| | • | MT is not allowed for HO and related RRM. |

In Table 1, even if the MT of the NCR transitions to the idle/inactive state, the FWD can remain in the ON state for the initially connected cell. In addition, since the MT is capable of cell reselection in the idle/inactive state, it may perform reselection to a cell other than the cell for which the FWD is currently performing amplification/forwarding according to the cell reselection criteria. In this regard, the disclosure proposes a method for matching the cell for which the FWD is performing amplification/forwarding and the cell with which the MT is associated, when there is a mismatch therebetween. A first solution (Sol1) herein refers to when cell reselection is disallowed for an inactive/idle NCR-MT. To this end, when the serving gNB transmits an RRCRelease message including an RRCRelease or suspendConfig field to the NCR-MT, the RRCRelease message may include an indication for prohibiting cell reselection in the above message. The MT having received the above indication may transition to idle or inactive mode and refrain from performing cell reselection. With or without the prohibiting indication, the MT may refrain from performing cell reselection when transitioning to idle or inactive mode. Even when cell reselection is not performed, to meet a specific signal level of the serving cell, the network must detect when the signal strength of the serving cell decreases to below a specific level. To this end, the serving gNB may transmit a reference signal received power (RSRP)/reference signal received quality (RSRQ) threshold to the UE.

The threshold, as an absolute value, may be one value or may consist of one offset value. In this case, the message may be RRCRelease (with or without suspendConfig).

The MT having received threshold information of a single absolute value may measure the signal strength of the current serving cell in idle/inactive mode. If the measured value is less than the received RSRP/RSRQ threshold, the MT may perform a resume or connection setup procedure.

Alternatively, the MT having received a single offset value may measure the signal strength of the current serving cell in idle/inactive mode. If the signal strength of the current serving cell is decreased by greater than the offset value with respect to the time point of receiving the RRC message including the offset value, the MT may perform a resume or connection setup procedure.

When transmitting an RRC resume or RRC setup message, the MT may include, as a cause value, an indication indicating serving cell signal degradation in the message.

A second solution (Sol2 herein refers to when the cell of NCR-FWD is changed to the cell reselected by MT.

In a first option (Opt1), when the MT performs cell reselection to thereby select a cell different from the current serving cell, and the MT is camping on the corresponding cell in a camped normally state, or when the MT is connected to the newly camped cell, the FWD may be turned off. Additionally, the NCR may perform an operation to change another cell selected by the MT to a new target cell of the FWD.

The RRCRelease (with or without suspendConfig) message may include an indication that directs the above operation.

The MT having received the above message may transition to idle/inactive mode, and then may internally transfer a signal to the FWD to turn off the FWD when performing cell reselection.

The serving BS may configure in advance conditional handover to connected mode UEs receiving the NCR service before delivering a message including the above indication to the NCR-MT. This is to prevent when the corresponding UEs suddenly lose their serving cells due to the FWD being turned off when the MT reselects a cell.

The BS of the newly selected cell may request context retrieve of NCR FWD and/or MT from the BS of the cell for which the FWD has performed amplification/forwarding. To this end, a context retrieve request message and a corresponding response message can be transmitted and received as an Xn message between the two BSs.

In a second option (Opt 2), the MT may perform normal cell reselection. If a different cell is reselected, the MT may indicate the FWD to change the cell. The FWD having received the above indication may remain in the ON state and amplify/forward the signal of the new cell while stopping the operation of amplifying/forwarding the signal of the existing cell.

The MT transmits an indication to change cell to the FWD internally, and the FWD autonomously changes its signal source.

A third solution (Sol3) herein refers to redirection of the MT to the original cell.

If the MT reselects a new cell, the MT may perform the RRC resume (if the MT is inactive) or RRC setup (if the MT is idle) procedure. In this case, the UL RRC message may include a new cause value.

The new cause value may indicate that redirection of the MT for NCR-FWD control is requested, or may indicate that the NCR-MT has performed reselection to a new cell.

Additionally, the MT can transmit signal strength measurement results of the cell for which the FWD has originally performed amplification/forwarding to the serving cell by including them in the UL RRC message. Alternatively, as in legacy operation, UEInformationReq/Resp. msg can be used for obtaining a measurement result in idle/inactive case.

The BS of the serving cell having received the UL RRC message may command a handover to the serving cell for which the FWD has performed amplification/forwarding. The measurement information of the original cell included in the UL RRC message may be considered.

The serving BS may determine to change the target of the FWD to the current serving cell instead of a handover to the original cell. In this case, the BS of the current serving cell may request NCR context retrieve from the BS of the original cell and obtain the results.

In this case, the current serving BS may command the MT, through the current serving cell, via DL RRC message, DL medium access control (MAC) control element (CE), or DL control information (DCI), to turn off the amplification/forwarding operation of the FWD for the original cell.

Alternatively, if the MT reselects a new cell, the MT may request resume or connection setup. The gNB of the corresponding serving cell may transmit an RRCReject message to the MT. In addition, redirection cell information can be included in the corresponding reject message.

In this case, the resume/setup request message transmitted by the MT may also include the new cause value and/or measurement information of the original cell used in case A.

The BS of the serving cell having received this request message may include the following information in the RRCReject or RRCrelease message.

Redirection cell info could be PCI (physical cell ID)/frequency info/CGI (cell global ID) for the original cell

The MT having received the above message may immediately perform reselection to the corresponding cell if the corresponding cell is found.

A fourth solution (Sol4) herein is now described. While the MT may perform cell reselection to another cell, the FWD may be allowed to continue amplification and forwarding for the existing cell regardless of this, and the FWD may additionally perform RRC resume or RRC connection setup with the newly camped cell to amplify/forward the signal of the new cell in the connected state.

In this case, the RRC resume/RRC setup request message including the new cause value in Sol3 above may be transmitted to the serving cell.

The BS having received this UL RRC message may transmit a resume or setup message to the MT and may then deliver control information to be used for amplification and forwarding as to the new cell to the MT through RRCReconfiguration message or DL MAC CE/DCI.

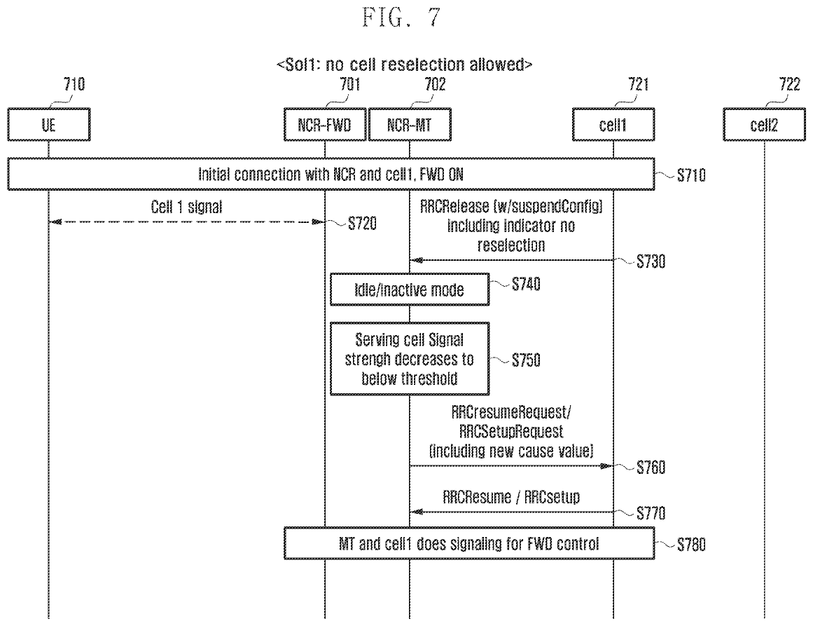

FIG. 7 illustrates when the MT is disallowed for cell reselection according to an embodiment.

In FIG. 7, NCR MT 702 and FWD 701 are in connected mode with cell 1 (721) in step S710.

The FWD 701 in ON state amplifies/forwards the signal of cell 1 (721) in step S720, amplifies the signal of UE 710 and forwards the signal to cell 1 (721).

In this situation, a command to transition MT 702 to idle or inactive mode may be received from cell 1 (721) in step S730. The RRCRelease (with or without suspendConfig) message may include an indication to no cell-reselection and may further include RSRP/RSRQ threshold information.

MT 702 having received the command may transition to idle/inactive mode in step S740 without performing cell reselection. Then, MT 702 may only measure the signal strength of the current serving cell. If the measured signal strength of the current serving cell decreases to below the given quality threshold in step S750, MT 702 may make a resume or setup request to cell 1 (721) in step S760. The RRCresumeRequest or

RRCsetupRequest message used in this case may include an NCR access indication or an indication to deterioration of the signal of the current serving cell as a cause value. Cell 1 (721) having received the above message may command MT (702) of the NCR to resume or setup in step S770 and may exchange signals for controlling beam information of the FWD 701 with MT 702.

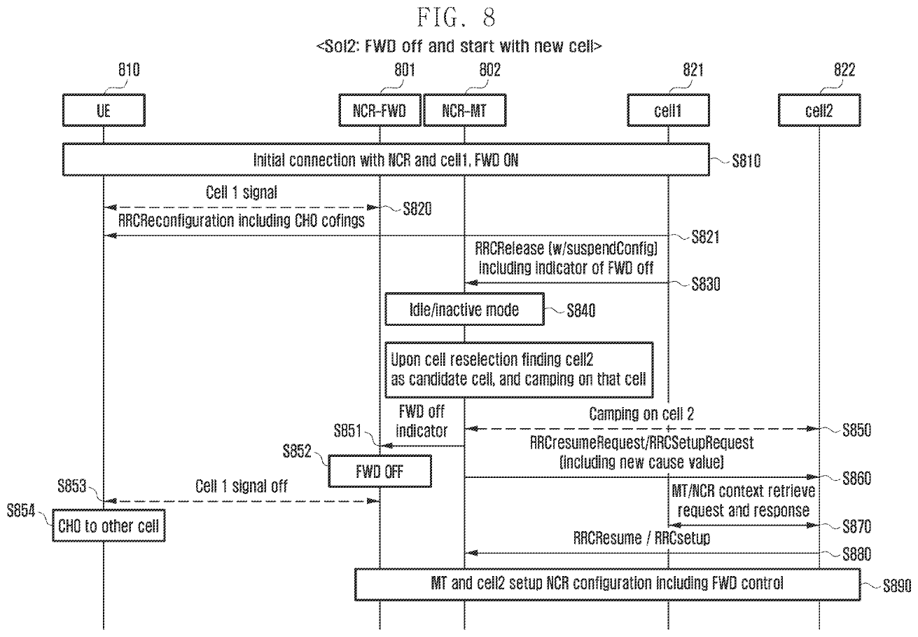

FIG. 8 illustrates when the MT is allowed for cell reselection but the FWD is turned off according to an embodiment.

In FIG. 8, the NCR MT 802 and FWD 801 are in connected mode with cell 1 (821) in step S810.

The FWD 801 amplifies/forwards the signal of cell 1 (821) in step S820, amplifies the signal of UE 810 and forwards this signal of UE 810 to cell 1 (821). Cell 1 (821) may configure in advance conditional handover to a cell other than cell 1 (821) to the connected mode UEs 810 served by the NCR in step S821.

Thereafter, the MT 802 may receive a command to transition to idle or inactive mode from cell 1 (821) in step S830. The RRCRelease (with suspendConfig) message may include an indication to turn off the FWD upon cell reselection.

The MT 802 having received the above command may transition to idle/inactive mode in step S840 and may perform cell reselection. The cell reselection is a process of finding a new cell according to a given metric based on measurements of candidate frequencies/cells. If MT 802 finds a new cell during this process and determines to camp on that cell, MT 802 may camp on the corresponding cell 822 (e.g., cell 2) in step S850, deliver an indication to change the FWD 801 to the off state to FWD 801 in step S851, and suspend signal amplification/forwarding of FWD 801 as to cell 1 (821) in step S852. When the UEs 810 that have exchanged signals with cell 1 (820) through FWD 801 are disabled from transmitting or receiving signals to or from with cell 1 (821) due to the OFF state of the FWD 801 in step S853, they may perform conditional handover to other cells based on the conditional handover configuration provided in advance by cell 1 (821) in step S854.

When the MT 802 camps on cell 2 (822) after reselection, MT 802 may make an RRC resume or connection setup request to cell 2 (822) in step S860. In this case, the RRC resume or connection setup request may include, as a new cause value, an indication that the NCR desires a new network connection.

The BS 822 of cell 2 having received the corresponding message may transmit a message requesting context retrieval for the NCR and MT 802 to the BS 821 of cell 1 in step S870 if necessary. In reply, through a context retrieve response, the BS 821 of cell 1 may provide the BS 822 of cell 2 with index information of the beam used on the access link for NCR control in the previous cell, frequency information of the cell, SCS (subcarrier spacing) information, and FWD ON/OFF time information in step S870.

Thereafter, the MT 802 having completed the RRC resume/RRC setup procedure with cell 2 (822) in step S880 may receive control information that enables the FWD 801 to amplify/forward the signal of cell 2 (822) from cell 2 (822) having received the above information and may control the FWD 801 based on this in step S890. In this case, the beam of the access link used in previous cell 1 (821) can be reused.

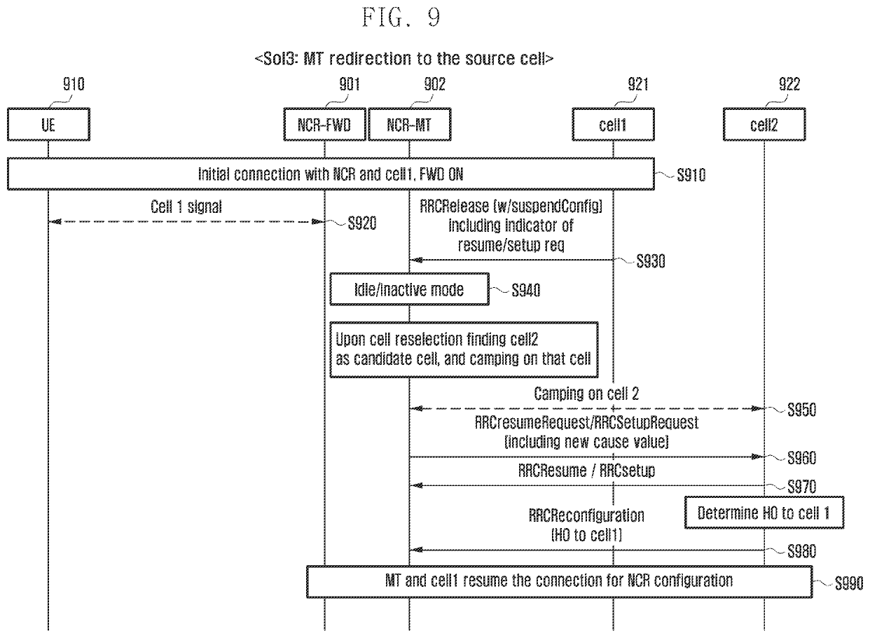

FIG. 9 illustrates when the MT is allowed for cell reselection but redirection is made to the original cell according to an embodiment.

Referring to FIG. 9, the NCR MT 902 and FWD 901 are in connected mode with cell 1 (921) in step S910.

The FWD 901 amplifies/forwards the signal of cell 1 (921) in step S920 and amplifies the signal of the UE 910 and forwards the signal to cell 1 (921).

Thereafter, MT 902 may receive a command to transition to idle or inactive mode from cell 1 (921) in step S930. The RRCRelease (with or without suspendConfig) message may include an indication to make a resume/setup request upon cell reselection.

After transitioning to idle/inactive mode in step S940, when MT 902 performs cell reselection to another cell 922 in step S950, MT 902 may transmit a resume/setup request message to cell 2 (922) according to the given indication in the message above in step S960. In this case, the resume/setup request message may include an indication that it is for NCR connection as a cause value.

Cell 2 (922) having received the above message may transmit an RRCresume or RRCsetup message to the NCR in step S970.

Thereafter, cell 2 (922) may command the NCR to perform handover to cell 1 (901) being the target for amplification/forwarding of FWD 901 based on measurement result information or the other in step S980. If determining not to perform handover, cell 2 (922) may turn off the FWD operation as to cell 1 (921) and then command MT 902 to newly set up the FWD operation as to cell 2 (922). This command may be indicated by a specific field “off-and-on with new cell” in an RRC message or may be indicated by a DL MAC CE or DCI.

The MT 902 having received the handover command may perform a handover to cell 1 (921) and receive information for controlling the NCR FWD 901 from cell 1 (921) in step S990.

Alternatively, when MT 902 transmits an RRCresumeRequest/RRCsetupRequest message to cell 2 (922), cell 2 (922) may transmit an RRCreject or release message to the MT 902, which may command MT 902 to redirect to cell 1 (921) being the original cell.

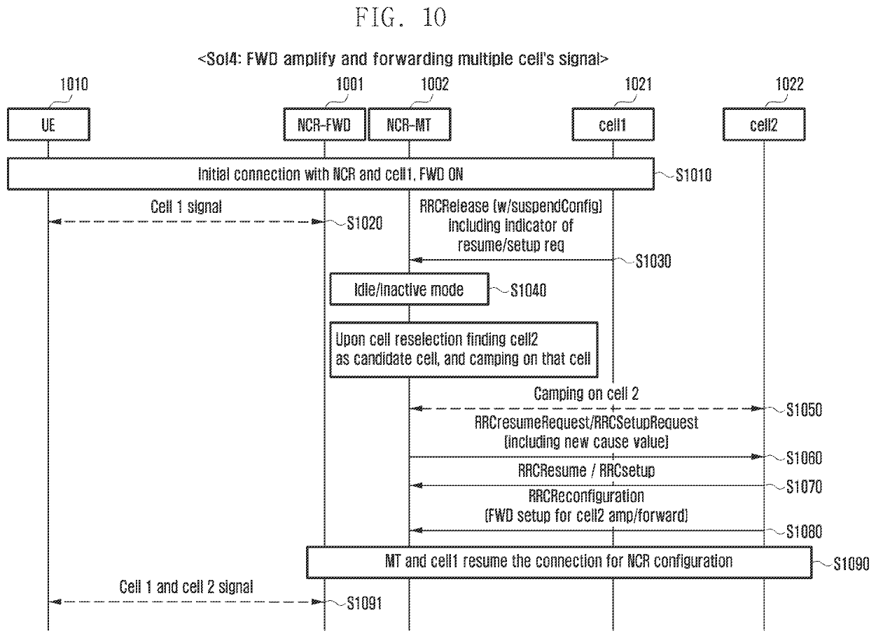

FIG. 10 illustrates when the FWD performs amplification/forwarding for plural cells according to an embodiment.

Referring to FIG. 10, the NCR MT 1002 and FWD 1001 are in connected mode with cell 1 (1021) in step S1010.

The FWD 1001 in the ON state amplifies/forwards the signal of cell 1 (1021) in step S1020, amplifies the signal of UE 1010 and forwards the signal of UE 1010 to cell 1 (1021).

Thereafter, MT 1002 may receive a command to transition to idle or inactive mode from cell 1 (1021) in step S1030. The RRCRelease (with or without suspendConfig) message may include an indication to make a resume/setup request upon cell reselection.

After transitioning to idle or inactive mode in step S1040, when MT 1002 performs cell reselection to cell 2 (1022) in step S1050, MT 1002 may transmit a resume or setup request message to cell 2 (1022) in step S1060 and may receive, as a response, an RRCresume or RRCsetup message from cell 2 (1022) in step S1070. In this case, the resume or setup request message may include an indication that it is for NCR connection as a new cause value.

The BS 1022 of cell 2 can exchange NCR/MT context with the BS 1021 of cell 1 as needed. This context may include capability information regarding whether the NCR can amplify/forward signals of multiple cells and may include at least one of information about the cell (e.g., cell 1) whose signal is currently amplified/forwarded, information about the access link beam being in use, or information about the frequency band of cell 1. Thus, cell 2 (1022) may identify that the corresponding MT 1002 is an NCR and identify that MT 1002 is currently amplifying/forwarding signals related to cell 1 (1021). For example, if the NCR is capable of amplifying/forwarding signals for multiple cells, cell 2 (1022) may newly perform a procedure with the NCR by transmitting the settings to amplify and forward signals of cell 2 to the NCR through an RRC reconfiguration message in step S1080, thereby controlling the NCR to perform amplification/forwarding of the signal of cell 2 (1022) in steps S1090 and S1091.

The methods according to the embodiments described herein may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments of the disclosure.

Such a program (software module, software) may be stored in a random access memory (RAM), a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Alternatively, such a program may be stored in a memory composed of a combination of some or all of them. In addition, a plurality of component memories may be included.

Such a program may be stored in an attachable storage device that can be accessed through a communication network such as the Internet, an intranet, a local area network (LAN), a wide LAN (WLAN), or a storage area network (SAN), or through a communication network composed of a combination thereof. Such a storage device may access the device that performs an embodiment of the disclosure through an external port. In addition, a separate storage device on a communication network may access the device that performs an embodiment.

The blocks of a flowchart (or sequence diagram) and a combination of flowcharts herein may be executed by computer program instructions loaded on a processor of a general purpose computer, special purpose computer or programmable data processing equipment. When the loaded program instructions are executed by the processor, they enable functions described in the flowchart to be performed. As the computer program instructions may be stored in a computer readable memory that is usable in a specialized computer or a programmable data processing equipment, it is also possible to create articles of manufacture that carry out functions described in the flowchart. As the computer program instructions may be loaded on a computer or a programmable data processing equipment, when executed as processes, they may carry out steps of functions described in the flowchart.

In addition, a block of a flowchart may correspond to a module, a segment or a code containing one or more executable instructions implementing one or more logical functions, or to a part thereof. In some cases, functions described by blocks may be executed in an order different from the listed order. For example, two blocks listed in sequence may be executed at the same time or executed in reverse order according to their corresponding functions.

In the description, the term unit, module or the like may refer to a software component or hardware component such as a field programmable gate array (FPGA) or application specific integrated circuit (ASIC) capable of carrying out a function or an operation. However, unit is not limited to hardware or software and may be configured so as to reside in an addressable storage medium or to drive one or more processors. Units or the like may refer to software components, object-oriented software components, class components, task components, processes, functions, attributes, procedures, subroutines, program code segments, drivers, firmware, microcode, circuits, data, databases, data structures, tables, arrays or variables. A function provided by a component and unit may be a combination of fewer components and units, and may be combined with others to compose more components and units that may be configured to drive a device or one or more processors in a secure multimedia card. A unit or the like may include one or more processors.

While this disclosure has been illustrated and described with reference to various embodiments of the present disclosure, those skilled in the art will understand that various changes can be made in form and detail without departing from the spirit and scope of the present disclosure as defined by the appended claims and their equivalents.

What is claimed is:

1. A method performed by a network-controlled repeater (NCR) node in a communication system, the method comprising:
performing, by a forward (Fwd) of the NCR node (NCR-Fwd), signal forwarding between a terminal and a base station based on first control information received from the base station;
receiving, by a mobile termination (MT) of the NCR node (NCR-MT), from the base station, a radio resource control (RRC) release message;
performing, by the NCR-MT, cell reselection in an RRC inactive state based on the RRC release message including information on a suspend configuration; and
indicating, by the NCR-MT, to the NCR-Fwd, to cease the signal forwarding, in case that the NCR-MT reselects a cell other than a last serving cell of the base station.

2. The method of claim 1, further comprising:
in case that the RRC release message does not include the information on the suspend configuration, transitioning to an RRC idle state from an RRC connected state; and
indicating, by the NCR-MT, to the NCR-Fwd, to cease the signal forwarding, based on the NCR-MT transitioning to the RRC idle state.

3. The method of claim 1, further comprising:
transmitting, by the NCR-MT, to a base station associated with the cell, an RRC resume request message based on the cell being reselected; and
receiving, by the NCR-MT, from the base station associated with the cell, an RRC resume message as a response to the RRC resume request message.

4. The method of claim 3,
wherein the RRC resume request message includes information indicating that the NCR node requests a connection to the base station associated with the cell.

5. The method of claim 3, further comprising:
receiving, by the NCR-MT, from the base station associated with the cell, second control information to forward a signal associated with the cell; and
applying, by the NCR-Fwd, the second control information.

6. The method of claim 1,
wherein the second control information includes at least one of information on a beam used by the signal forwarding associated with the last serving cell, information on a frequency of the cell, or information on subcarrier spacing.

7. The method of claim 5, further comprising:
forwarding, by the NCR-Fwd, a signal associated with the last serving cell based on the first control information and the signal associated with the cell based on the second control information.

8. A network-controlled repeater (NCR) node in a communication system, the NCR node comprising:
a transceiver; and
a controller configured to:
control a forward (Fwd) of the NCR node (NCR-Fwd) to perform signal forwarding between a terminal and a base station based on first control information received from the base station,
control a mobile termination (MT) of the NCR node (NCR-MT) to receive, from the base station, a radio resource control (RRC) release message,
control the NCR-MT to perform cell reselection in an RRC inactive state based on the RRC release message including information on a suspend configuration, and
control the NCR-MT to indicate, to the NCR-Fwd, ceasing of the signal forwarding, in case that the NCR-MT reselects a cell other than a last serving cell of the base station.

9. The NCR node of claim 8, wherein the controller is further configured to:
in case that the RRC release message does not include the information on the suspend configuration, control the NCR-MT to transition to an RRC idle state from an RRC connected state, and
control the NCR-MT to indicate, to the NCR-Fwd, to cease the signal forwarding, based on the NCR-MT transitioning to the RRC idle state.

10. The NCR node of claim 8, wherein the controller is further configured to:
control the NCR-MT to transmit, to a base station associated with the cell, an RRC resume request message based on the cell being reselected, and
control the NCR-MT to receive, from the base station associated with the cell, an RRC resume message as a response to the RRC resume request message.

11. The NCR node of claim 10,
wherein the RRC resume request message includes information indicating that the NCR node requests a connection to the base station associated with the cell.

12. The NCR node of claim 10, wherein the controller is further configured to:
control the NCR-MT to receive, from the base station associated with the cell, second control information to forward a signal associated with the cell; and
control the NCR-Fwd to apply the second control information.

13. The NCR node of claim 8,
wherein the second control information includes at least one of information on a beam used by the signal forwarding associated with the last serving cell, information on a frequency of the cell, or information on subcarrier spacing.

14. The NCR node of claim 12,
wherein the controller is further configured to control the NCR-Fwd to forward a signal associated with the last serving cell based on the first control information and the signal associated with the cell based on the second control information.
